(19) United States
(12) Patent Application Publication
(10) Pub. No.: US 2024/0250385 A1
(43) Pub. Date: Jul. 25, 2024

(54) ALL SOLID BATTERY, CIRCUIT SUBSTRATE AND MANUFACTURING METHOD OF ALL SOLID BATTERY

(71) Applicant: TAIYO YUDEN CO., LTD., Tokyo (JP)

(72) Inventor: Takato SATO, Tokyo (JP)

(73) Assignee: TAIYO YUDEN CO., LTD., Tokyo (JP)

(21) Appl. No.: 18/491,413

(22) Filed: Oct. 20, 2023

(30) Foreign Application Priority Data
Nov. 17, 2022 (JP) 2022-183840

(51) Int. Cl. H01M 50/457; H01M 50/403; H01M 50/437

(52) U.S. Cl. CPC H01M 50/457; H01M 50/403; H01M 50/437

(57) ABSTRACT

An all solid battery includes a multilayer structure in which each of a plurality of solid electrolyte layers and each of a plurality of internal electrodes including an electrode active material are alternately stacked, a first cover layer provided on a first end of the multilayer structure in a stacking direction, and a second cover layer provided on a second end of the multilayer structure in the stacking direction. The first cover layer and the second cover layer include a solid electrolyte and filler materials dispersed in the solid electrolyte. One of the plurality of solid electrolyte layers not including the filler materials is arranged between the first cover layer and one of the plurality of internal electrodes located closest to the first cover layer. The second cover layer directly contacts another one of the plurality of internal electrodes located closest to the second cover layer.

### CROSS-REFERENCE TO RELATED APPLICATION

This application is based upon and claims the benefit of priority of the prior Japanese Patent Application No. 2022-183840, filed on Nov. 17, 2022, the entire contents of which are incorporated herein by reference.

### FIELD

A certain aspect of the present invention relates to an all solid battery, a circuit substrate and a manufacturing method of the all solid battery.

### BACKGROUND

Stacked all solid batteries are safe and easy-to-handle secondary batteries that do not have to worry about fire or leakage, and can be reflow-soldered (see, for example, International Publication No. 2018/186449, International Publication No. 2020/070989, International Publication No. 2021/070927, and Japanese Patent Application Publication No. 2017-182945). A transition from conventional lithium-ion batteries using liquid electrolyte is being considered, and it is expected that they will be used in a wide range of fields.

### SUMMARY OF THE INVENTION

According to an aspect of the present invention, there is provided an all solid battery including: a multilayer structure in which each of a plurality of solid electrolyte layers and each of a plurality of internal electrodes including an electrode active material are alternately stacked; a first cover layer provided on a first end of the multilayer structure in a stacking direction; and a second cover layer provided on a second end of the multilayer structure in the stacking direction, wherein the first cover layer and the second cover layer include a solid electrolyte and filler materials dispersed in the solid electrolyte, wherein one of the plurality of solid electrolyte layers not including the filler materials is arranged between the first cover layer and one of the plurality of internal electrodes located closest to the first cover layer, and wherein the second cover layer directly contacts another one of the plurality of internal electrodes located closest to the second cover layer.

According to another aspect of the present invention, there is provided a circuit substrate including a substrate; and the all solid battery mounted on the substrate, wherein the first cover layer of the all solid battery faces the substrate.

According to an aspect of the present invention, there is provided a manufacturing method of an all solid battery including: forming a multilayer structure by stacking a plurality of stack units, each having a structure in which an internal electrode pattern including an electrode active material powder is formed on a solid electrolyte green sheet including solid electrolyte powder; stacking a cover sheet on an upper face and a lower face in a stacking direction of the multilayer structure, the cover sheet including a solid electrolyte and a filler material which is less likely causes necking than the solid electrolyte; and firing the multilayer structure and the cover sheet, wherein the solid electrolyte green sheet does not include the filler material.

### BRIEF DESCRIPTION OF THE DRAWINGS

FIG. 1 illustrates a schematic cross section of a basic structure of an all solid battery;

FIG. 2 illustrates a schematic cross section of a stacked all solid battery in which battery units are stacked;

FIG. 3 illustrates a schematic cross section of a stacked all solid battery in which battery units are stacked;

FIG. 4 illustrates a cover layer;

FIG. 5 illustrates a circuit substrate;

FIG. 6 illustrates a flowchart of a manufacturing method of an all solid battery; and

FIG. 7A and FIG. 7B illustrate a stacking process.

### DETAILED DESCRIPTION

Such an all solid battery is soldered to a substrate by reflow. However, due to the tensile stress of the solder during reflow, there is a risk that peeling will occur between the cover layer and the internal electrode in the all solid battery. In this case, there is a possibility that high reliability may not be necessarily obtained from the all solid battery.

A description will be given of an embodiment with reference to the accompanying drawings.

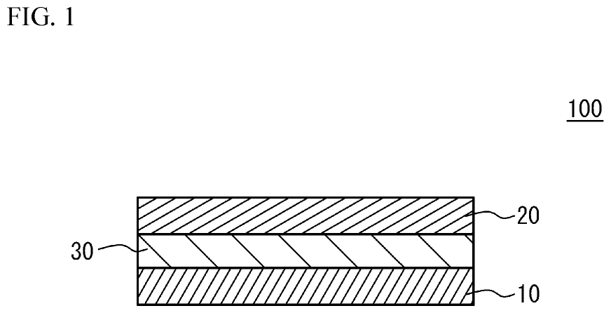

(Embodiment) FIG. 1 illustrates a schematic cross section of a basic structure of an all solid battery 100 in accordance with an embodiment. As illustrated in FIG. 1, the all solid battery 100 has a structure in which a first internal electrode 10 (first internal electrode layer) and a second internal electrode 20 (second internal electrode layer) sandwich a solid electrolyte layer 30. The first internal electrode 10 is provided on a first main face of the solid electrolyte layer 30. The second internal electrode 20 is provided on a second main face of the solid electrolyte layer 30. For example, the first internal electrode 10, the second internal electrode 20 and the solid electrolyte layer 30 have a sintered body which is formed by sintering powder materials.

When the all solid battery 100 is used as a secondary battery, one of the first internal electrode 10 and the second internal electrode 20 is used as a positive electrode and the other is used as a negative electrode. In the embodiment, as an example, the first internal electrode 10 is used as a positive electrode, and the second internal electrode 20 is used as a negative electrode.

A main component of the solid electrolyte layer 30 is an oxide-based solid electrolyte having a NASICON crystal structure and having ion conductivity. For example, the solid electrolyte of the solid electrolyte layer 30 is oxide-based solid electrolyte having lithium ion conductivity. For example, the solid electrolyte is phosphoric acid salt-based electrolyte. The phosphoric acid salt-based solid electrolyte having the NASICON crystal structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, it is preferable that Li—Al—Ge—PO₄-based material, to which a transition metal included in the phosphoric acid salt having the olivine type crystal structure included in the first internal electrode 10 and the second internal electrode 20 is added in advance, is used. For example, when the first internal electrode 10 and the second internal electrode 20 include phosphoric acid salt including Co and Li, it is preferable that the solid electrolyte layer 30 includes Li—Al—Ge—PO₄-based material to which Co is added in advance. In this case, it is possible to suppress solving of the transition metal included in the electrode active material into the electrolyte. When the first internal electrode 10 and the second internal electrode 20 include phosphoric acid salt including Li and a transition metal other than Co, it is preferable that the solid electrolyte layer 30 includes Li—Al—Ge—PO₄-based material in which the transition metal is added in advance.

At least, the first internal electrode 10 used as the positive electrode includes a material having an olivine type crystal structure, as an electrode active material. It is preferable that the second internal electrode 20 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

The electrode active material having the olivine type crystal structure acts as a positive electrode active material in the first internal electrode 10 acting as the positive electrode. For example, when only the first internal electrode 10 includes the electrode active material having the olivine type crystal structure, the electrode active material acts as the positive electrode active material. When the second internal electrode 20 also includes an electrode active material having the olivine type crystal structure, discharge capacity may increase and an operation voltage may increase because of electric discharge, in the second internal electrode 20 acting as the negative electrode. The function mechanism is not completely clear. However, the mechanism may be caused by partial solid-phase formation together with the negative electrode active material.

When both the first internal electrode 10 and the second internal electrode 20 include an electrode active material having the olivine type crystal structure, the electrode active material of each of the first internal electrode 10 and the second internal electrode 20 may have a common transition metal. Alternatively, the a transition metal of the electrode active material of the first internal electrode 10 may be different from that of the second internal electrode 20. The first internal electrode 10 and the second internal electrode 20 may have only single type of transition metal. The first internal electrode 10 and the second internal electrode 20 may have two or more types of transition metal. It is preferable that the first internal electrode 10 and the second internal electrode 20 have a common transition metal. It is more preferable that the electrode active materials of the both electrode layers have the same chemical composition. When the first internal electrode 10 and the second internal electrode 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The second internal electrode 20 may include known material as the negative electrode active material. When only one of the electrode layers includes the negative electrode active material, it is clarified that the one of the electrode layers acts as a negative electrode and the other acts as a positive electrode. When only one of the electrode layers includes the negative electrode active material, it is preferable that the one of the electrode layers is the second internal electrode 20. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

In the forming process of the first internal electrode 10 and the second internal electrode 20, moreover, oxide-based solid electrolyte material or a conductive material (conductive auxiliary agent) may be added. When the material is evenly dispersed into water or organic solution together with binder or plasticizer, paste for electrode layer is obtained. In the embodiment, the electrode layer paste includes a carbon material as the conductive auxiliary agent. Moreover, the electrode may include a metal as the conductive auxiliary agent. Pd, Ni, Cu, or Fe, or an alloy thereof may be used as a metal of the conductive auxiliary agent. The solid electrolyte included in the first internal electrode 10 and the second internal electrode 20 may be the same as the solid electrolyte which is the main component of the solid electrolyte layer 30.

The thickness of the solid electrolyte layer 30 is, for example, 5 μm or more and 30 μm or less, 7 μm or more and 25 μm or less, and 10 μm or more and 20 μm or less. The thickness of the first internal electrode 10 and the second internal electrode 20 is, for example, 5 μm or more and 50 μm or less, 7 μm or more and 45 μm or less, and 10 μm or more and 40 μm or less. The thickness of each layer can be measured, for example, as the average value of the thicknesses at 10 different points of one layer.

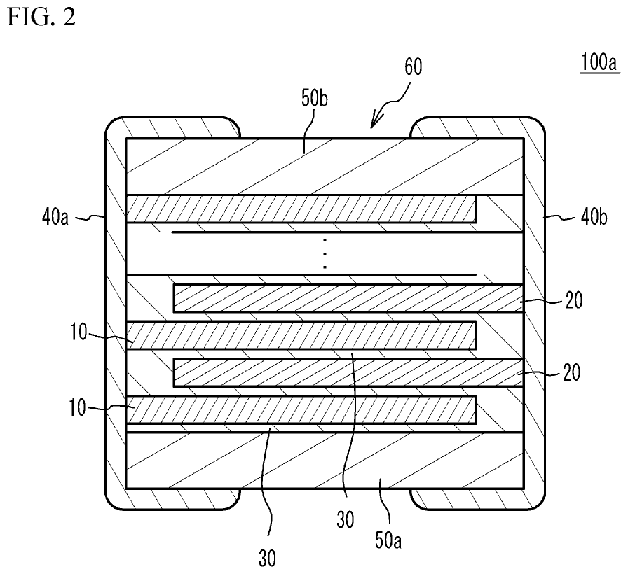

FIG. 2 is a partial cross-sectional perspective view of a stacked all-solid-state battery 100a in which a plurality of battery units are stacked. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In the following description, the same numeral is added to each member that has the same composition range, the same thickness range and the same particle distribution range as that of the all solid battery 100. And, a detail explanation of the same member is omitted.

In the all solid battery 100a, the plurality of first internal electrodes 10 and the plurality of second internal electrodes 20 are alternately stacked with the solid electrolyte layers 30 in between. The number of the first internal electrodes 10 and the number of the second internal electrodes 20 may be the same as each other. One of the numbers may be larger than the other by one layer. The edges of the plurality of first internal electrodes 10 are exposed to the first end face of the multilayer chip 60 and are not exposed to the second end face. The edges of the plurality of second internal electrodes 20 are exposed to the second end face of the multilayer chip 60 and are not exposed to the first end face. Thereby, the first internal electrode 10 and the second internal electrode 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A first cover layer 50a is stacked on the lower face of the multilayer body of the first internal electrodes 10, the solid electrolyte layers 30, and the second internal electrodes 20. A second cover layer 50b is stacked on the upper face of the multilayer body. The second cover layer 50b is in direct contact with the uppermost internal electrode (one of the first internal electrode 10 and the second internal electrode 20) and is in contact with a part of the solid electrolyte layer 30. The solid electrolyte layer 30 is interposed between the first cover layer 50a and the lowermost internal electrode (one of the first internal electrode 10 and the second internal electrode 20). For example, the first cover layer 50a and the second cover layer 50b are sintered bodies obtained by sintering powder materials.

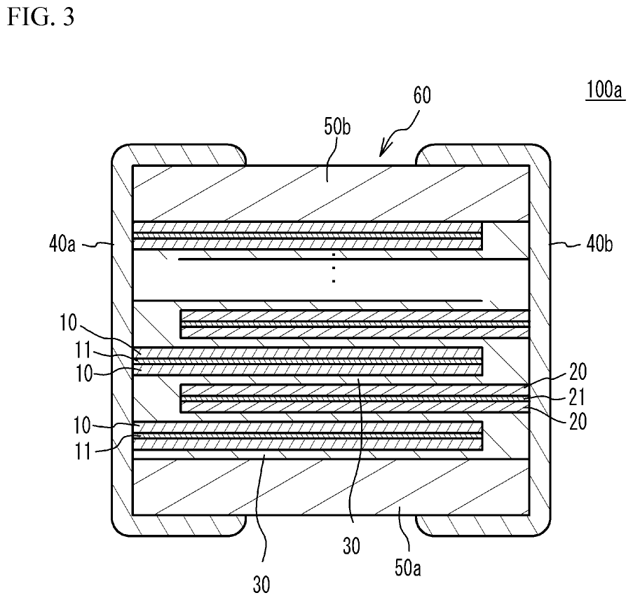

Each of the first internal electrode 10 and the second internal electrode 20 may include a current collector layer. For example, as illustrated in FIG. 3, a first current collector layer 11 may be provided within the first internal electrode 10. Further, a second current collector layer 21 may be provided within the second internal electrode 20. The first current collector layer 11 and the second current collector layer 21 have a conductive material as a main component. For example, metal, carbon, or the like can be used as the conductive material for the first current collector layer 11 and the second current collector layer 21. By connecting the first current collector layer 11 to the first external electrode 40a and connecting the second current collector layer 21 to the second external electrode 40b, current collection efficiency is improved.

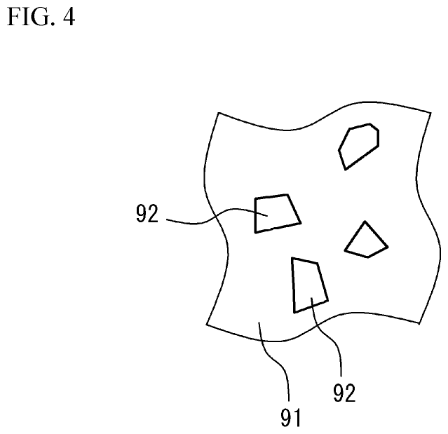

The first cover layer 50a and the second cover layer 50b include a solid electrolyte 91 and a filler material 92, as illustrated in FIG. 4. The solid electrolyte 91 forms a bone structure by necking. A plurality of gaps are formed by this bone structure. The filler material 92 is placed in this gap. Therefore, in the bone structure formed by the solid electrolyte 91 that is spatially continuous, the filler materials 92 are arranged in a spatially dispersed manner. The filler material 92 is a crystalline material having a different composition from that of the solid electrolyte 91.

For example, the solid electrolyte 91 is preferably a material that easily causes necking and forms a bone structure when firing the all solid battery 100a. For example, as the solid electrolyte 91, a glass material, an oxide-based solid electrolyte material or the like can be used. From the viewpoint of adhesion of the first cover layer 50a and the second cover layer 50b, it is preferable that the solid electrolyte 91 has a common structure with the oxide-based solid electrolyte that is the main component of the solid electrolyte layer 30, the oxide-based solid electrolyte that is included in the first internal electrode 10 and the oxide-based solid electrolyte included in the second internal electrode 20. For example, the solid electrolyte 91 preferably has a NASICON crystal structure. Moreover, it is preferable that the solid electrolyte 91 has the same composition as the oxide-based solid electrolyte that is the main component of the solid electrolyte layer 30. Moreover, it is preferable that the solid electrolyte 91 has the same composition as the solid electrolyte included in the first internal electrode 10. Moreover, it is preferable that the solid electrolyte 91 has the same composition as the solid electrolyte included in the second internal electrode 20. As the solid electrolyte 91, for example, Li—Al—Ge—PO₄-based material (LAGP), Li—Al—Zr—PO₄, Li—Al—Ti—PO₄ or the like can be used.

The filler material 92 is preferably a material that is less likely to cause necking than the solid electrolyte 91 when firing the all solid battery 100a. For example, it is preferable to use alumina, silica, magnesia, titania or the like, as the filler material 92.

In this embodiment, the solid electrolyte layer 30 does not contain any filler material.

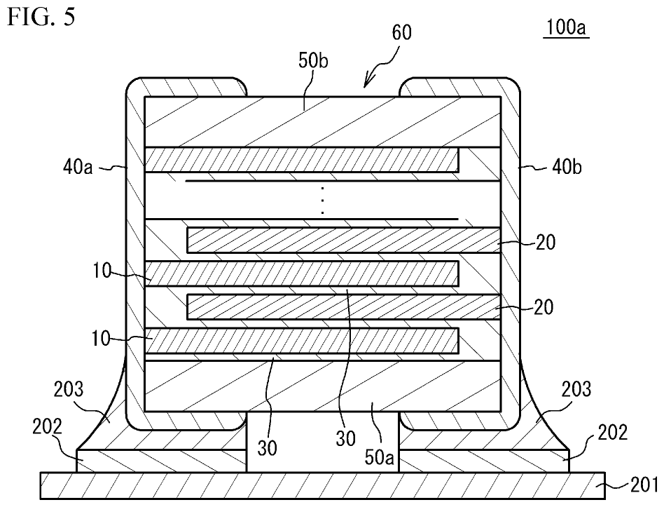

FIG. 5 illustrates a circuit substrate 200. As illustrated in FIG. 5, the circuit substrate 200 has a configuration in which the all solid battery 100a is mounted on a substrate 201. As illustrated in FIG. 5, the all solid battery 100a is arranged such that the lower face thereon in the stacking direction faces a land 202 on the circuit substrate 200. Therefore, the first cover layer 50a faces the substrate 201. The first external electrode 40a and the second external electrode 40b are each independently electrically connected to each of the lands 202 on the substrate 201 via a solder 203.

The all solid battery 100a according to this embodiment includes the first cover layer 50a and the second cover layer 50b. The first cover layer 50a and the second cover layer 50b contain the solid electrolyte 91 and the filler material 92. Since the necking between the solid electrolyte 91 and the filler material 92 is not as strong as the necking between the solid electrolyte 91, even if volumetric expansion and contraction occur in the electrode active material during charging and discharging, displacement can be absorbed. Therefore, by providing the first cover layer 50a and the second cover layer 50b, delamination can be suppressed.

On the other hand, since the filler material 92 is less likely to neck, the bonding strength to the internal electrodes becomes low. The reason for this is that the firing temperature range in which the solid electrolyte becomes densified and the temperature range in which the filler material 92 becomes densified are different, and the temperature range in which the solid electrolyte becomes densified by firing is in a much lower temperature range in which the filler material becomes densified. However, in this embodiment, the solid electrolyte layer 30 that does not contain filler material is provided between the first cover layer 50a and the lowermost internal electrode. Since the solid electrolyte layer 30 does not contain a filler material, the solid electrolyte layer 30 has high bonding strength to the internal electrodes. Since both the first cover layer 50a and the solid electrolyte layer 30 contain a solid electrolyte, high bonding strength can also be obtained between the first cover layer 50a and the solid electrolyte layer 30. Thereby, peeling from the first cover layer 50a to the internal electrodes can be suppressed. For example, even if tensile stress is generated in the solder 203 during reflow, peeling can be suppressed.

The thickness of the first cover layer 50a and the second cover layer 50b is, for example, 10 μm or more and 500 μm or less, 20 μm or more and 300 μm or less, and 30 μm or more and 100 μm or less.

From the viewpoint of suppressing interlayer peeling due to a mismatch in shrinkage rates between the electrode layer and the cover layer in the firing process, it is preferable to set a lower limit on the ratio of the filler material 92 in the first cover layer 50a and the second cover layer 50b. The ratio of the filler material 92 refers to the area ratio of the filler material 92/(the solid electrolyte 91+the filler material) in a cross section including the stacking direction. In this embodiment, the ratio of the filler material 92 in the first cover layer 50a and the second cover layer 50b is preferably 10% or more, more preferably 30% or more, and even more preferably 50% or more.

On the other hand, from the viewpoint of improving the adhesion with the electrode layer after firing, it is preferable to set a lower limit to the ratio of the filler material 92 in the first cover layer 50a and the second cover layer 50b. In this embodiment, the ratio of the filler material 92 in the first cover layer 50a and the second cover layer 50b is preferably 90% or less, more preferably 80% or less, and even more preferably 70% or less.

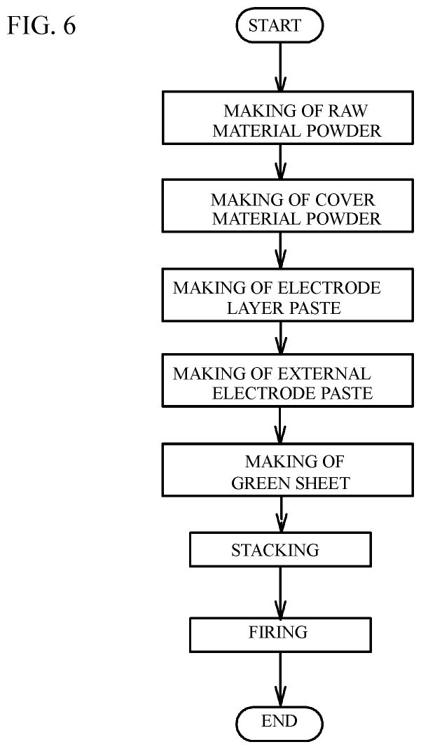

A description will be given of a manufacturing method of the all solid battery 100a described on the basis of FIG. 2. FIG. 6 illustrates a flowchart of the manufacturing method of the all solid battery 100a.

(Making process of raw material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ϕ. The raw material powder for the oxide-based solid electrolyte does not include the filler material.

(Making process of raw material powder for cover layer) A raw material powder of ceramics for the first cover layer 50a and the second cover layer 50b is made. For example, it is possible to make the raw material powder for the cover layer, by mixing raw material and additives and using solid phase synthesis method or the like. The resulting powder is subjected to dry grinding. The raw material powder includes a raw material for the solid electrolyte 91 and a raw material for the filler material 92.

(Making process for electrode layer paste) Next, internal electrode pastes for making the first internal electrode 10 and the second internal electrode 20 described above are separately made. For example, a paste for internal electrodes can be obtained by uniformly dispersing a conductive aid, an electrode active material, a solid electrolyte material, a sintering aid, a binder, a plasticizer and so on in water or an organic solvent. The solid electrolyte paste described above may be used as the solid electrolyte material. A carbon material or the like is used as a conductive aid. A metal may be used as the conductive aid. Examples of the metal of the conductive aid include Pd, Ni, Cu, Fe, and alloys containing these. Pd, Ni, Cu, Fe, alloys containing these, various carbon materials, and so on may also be used.

The additive includes sintering assistant. The sintering assistant includes one or more of glass components such as Li—B—O-based compound, Li—Si—O-based compound, Li—C—O-based compound, Li—S—O-based compound and Li—P—O-based compound.

(Making process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method. The solid electrolyte green sheet does not include the filler material.

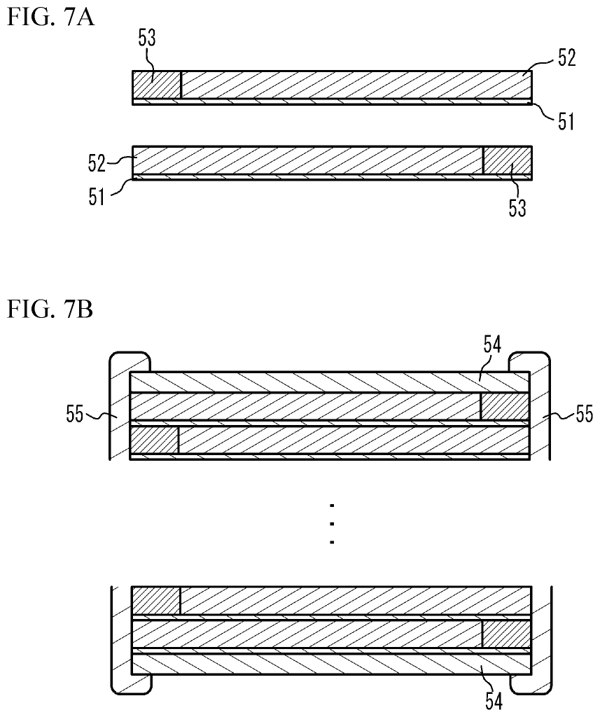

(Stacking process) As illustrated in FIG. 7A, an internal electrode paste 52 is printed on one side of the solid electrolyte green sheet 51. A reverse pattern 53 is printed on the peripheral area of the solid electrolyte green sheet 51 where the internal electrode paste 52 is not printed. The same material for the solid electrolyte green sheet 51 ca be used as the reverse pattern 53. The solid electrolyte green sheet 51 after the printing can be used as a stack unit. The plurality of solid electrolyte green sheets 51 are stacked so as to be alternately shifted. As illustrated in FIG. 7B, a multilayer structure is obtained by pressing the cover sheet 54 from above and below in the stacking direction. In this case, in the multilayer structure, the internal electrode paste 52 for the first internal electrode 10 is exposed on one end surface, and the internal electrode paste 52 for the second internal electrode 20 is exposed on the other end surface. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an eternal electrode paste 55 is applied to two end faces of the multilayer structure by dipping or the like and is dried. Thus, a compact for forming the all solid battery 100a is obtained.

(Firing process) Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° ° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the all solid battery 100a is formed.

By sequentially stacking the internal electrode paste, the current collector paste containing a conductive material, and the internal electrode paste, a current collector layer can be formed in the first internal electrode 10 and the second internal electrode 20. can be formed.

According to the manufacturing method according to the present embodiment, since the cover sheet includes the solid electrolyte 91 and the filler material 92, the solid electrolyte 91 forms a bone structure by necking, and the filler material 92 is dispersedly arranged in the bone structure. Further, the solid electrolyte layer 30 containing no filler material is formed between the first cover layer 50a and the lowermost internal electrode.

### EXAMPLES

(Example 1) A stacked all solid battery was produced according to the above embodiment. A first internal electrode paste for the first internal electrode (positive electrode layer) was applied and formed on the first solid electrolyte green sheet by a screen printing method. A second internal electrode paste for the second internal electrode (negative electrode layer) was applied and formed on the second solid electrolyte green sheet by a screen printing method. A plurality of first solid electrolyte green sheets and a plurality of second solid electrolyte green sheets were stacked so that the positive electrode layer and the negative electrode layer were alternately pulled Cover sheets were placed on the top and bottom surfaces of the resulting multilayer structure, which was then cut to a predetermined size to obtain a green chip for a stacked all solid battery. The green chip was sintered by degreasing and firing, and external electrodes were formed by applying and curing an external electrode paste to obtain a stacked all solid battery.

The cover sheet contained both a solid electrolyte and a filler material. A Li—Al—Ge—PO₄-based material (LAGP) was used as the solid electrolyte. Alumina was used as the filler material. The first solid electrolyte green sheet and the second solid electrolyte green sheet did not contain the filler material. A Li—Al—Ge—PO₄-based material (LAGP) was used as the oxide-based solid electrolyte of the first solid electrolyte green sheet and the second solid electrolyte green sheet.

The ratio of the filler material in the cover layer was 40%. The thickness of the cover layer was 150 μm. The ratio of the filler material in the solid electrolyte layer was 0%. The thickness of the solid electrolyte layer between the lower cover layer and the lowermost internal electrode was 10 μm.

(Example 2) The ratio of the filler material in the cover layer was 60%. The thickness of the cover layer was 150 μm. The ratio of the filler material in the solid electrolyte layer was 0%. The thickness of the solid electrolyte layer between the lower cover layer and the lowermost internal electrode was 10 μm. Other conditions were the same as in Example 1.

(Example 3) The ratio of the filler material in the cover layer was 40%. The thickness of the cover layer was 50 μm. The ratio of the filler material in the solid electrolyte layer was 0%. The thickness of the solid electrolyte layer between the lower cover layer and the lowermost internal electrode was 10 μm. Other conditions were the same as in Example 1.

(Example 4) The ratio of the filler material in the cover layer was 40%. The thickness of the cover layer was 150 μm. The ratio of the filler material in the solid electrolyte layer was 0%. The thickness of the solid electrolyte layer between the lower cover layer and the lowermost internal electrode was 5 μm. Other conditions were the same as in Example 1.

(Example 5) The ratio of the filler material in the cover layer was 40%. The thickness of the cover layer was 150 μm. The ratio of the filler material in the solid electrolyte layer was 0%. The thickness of the solid electrolyte layer between the lower cover layer and the lowermost internal electrode was 20 μm. Other conditions were the same as in Example 1.

(Comparative example 1) In Comparative Example 1, the filler material was included in the bottom solid electrolyte green sheet. Therefore, after firing, the lowermost solid electrolyte green sheet and cover sheet became the cover layer. The ratio of the filler material in the cover layer was 40%. The thickness of the cover layer was 150 μm. The ratio of the filler material in the solid electrolyte layer was 30%. The thickness of the solid electrolyte layer between the lower cover layer and the lowermost internal electrode was 10 μm. Other conditions were the same as in Example 1.

(Comparative example 2) The ratio of the filler material in the cover layer was 40%. The thickness of the cover layer was 150 μm. The ratio of the filler material in the solid electrolyte layer was 0%. No solid electrolyte layer was provided between the lower cover layer and the lowermost internal electrode. Other conditions were the same as in Example 1.

(Comparative example 3) The ratio of the filler material in the cover layer was 40%. The thickness of the cover layer was 50 μm. The ratio of the filler material in the solid electrolyte layer was 30%. The thickness of the solid electrolyte layer between the lower cover layer and the lowermost internal electrode was 10 μm. Other conditions were the same as in Example 1.

(Comparative example 4) The ratio of the filler material in the cover layer was 40%. The thickness of the cover layer was 150 μm. The ratio of the filler material in the solid electrolyte layer was 20%. The thickness of the solid electrolyte layer between the lower cover layer and the lowermost internal electrode was 10 μm. Other conditions were the same as in Example 1.

(Comparative example 5) The ratio of the filler material in the cover layer was 60%. The thickness of the cover layer was 150 μm. The ratio of the filler material in the solid electrolyte layer was 30%. The thickness of the solid electrolyte layer between the lower cover layer and the lowermost internal electrode was 10 μm. Other conditions were the same as in Example 1.

(Cycle characteristic test) For each of the all solid batteries of Examples 1 to 5 and Comparative Examples 1 to 5, a cycle characteristic test was conducted before reflow and after mounting on a substrate by reflow. In the cycle characteristic test, a charge/discharge cycle test was conducted at 0.2 C with an upper limit voltage of 3.3V and a lower limit voltage of 2.0V in a 25° C. environment.

Table 1 shows the results. As a result of the cycle characteristic test, if the discharge capacity maintenance rate after 2000 cycles with respect to the 1st cycle was 85% or more and 100% or less, it is judged as good “∘”. If the rate was less than 85%, it is judged as slightly bad “x”. In Examples 1 to 5, both before and after reflow, the cycle characteristic test was judged to be a good “∘”. This is because a solid electrolyte layer that did not contain filler material was formed between the lower cover layer and the lowermost internal electrode, which suppressed delamination even if tensile stress was generated in the solder. On the other hand, in Comparative Examples 1 to 5, the cycle characteristic test was judged as good “∘” before reflow, but the cycle characteristic test was judged as bad “x” after the reflow. This is because a solid electrolyte layer containing no filler material was not formed between the lower cover layer and the lowermost internal electrode, so when tensile stress was generated in the solder, interlayer peeling occurred between the cover layer and the internal electrode.

TABLE 1

| | | | | | | | CYCLE | |
|---|---|---|---|---|---|---|---|---|
| | FILLER | | | FILLER RATIO | THICKNESS | | CHARACTERISTIC | |
| | RATIO | THICKNESS | | IN SOLID | OF SOLID | | TEST | |
| | IN COVER | OF COVER | | DLECTROLYTE | ELECTROLYTE | | BEFORE | AFTER |
| | LAYER | LAYER | | LAYER | LAYER | | REFLOW | REFLOW |
| EXAMPLE 1 | 40% | 150 | μm | 0% | 10 | μm | ∘ | ∘ |
| EXAMPLE 2 | 60% | 150 | μm | 0% | 10 | μm | ∘ | ∘ |
| EXAMPLE 3 | 40% | 50 | μm | 0% | 10 | μm | ∘ | ∘ |
| EXAMPLE 4 | 40% | 150 | μm | 0% | 5 | μm | ∘ | ∘ |
| EXAMPLE 5 | 40% | 150 | μm | 0% | 20 | μm | ∘ | ∘ |
| COMPARATIVE | 40% | 150 | μm | 30% | 10 | μm | ∘ | x |
| EXMAPLE 1 | | | | | | | | |
| COMPARATIVE | 40% | 150 | μm | 0% | 0 | μm | ∘ | x |
| EXMAPLE 2 | | | | | | | | |
| COMPARATIVE | 40% | 50 | μm | 30% | 10 | μm | ∘ | x |
| EXMAPLE 3 | | | | | | | | |
| COMPARATIVE | 40% | 150 | μm | 20% | 10 | μm | ∘ | x |
| EXMAPLE 4 | | | | | | | | |
| COMPARATIVE | 60% | 150 | μm | 30% | 10 | μm | ∘ | x |
| EXMAPLE 5 | | | | | | | | |

Although the embodiments of the present invention have been described in detail, it is to be understood that the various change, substitutions, and alterations could be made hereto without departing from the spirit and scope of the invention.

What is claimed is:

1. An all solid battery comprising:
a multilayer structure in which each of a plurality of solid electrolyte layers and each of a plurality of internal electrodes including an electrode active material are alternately stacked;
a first cover layer provided on a first end of the multilayer structure in a stacking direction; and
a second cover layer provided on a second end of the multilayer structure in the stacking direction,
wherein the first cover layer and the second cover layer include a solid electrolyte and filler materials dispersed in the solid electrolyte,
wherein one of the plurality of solid electrolyte layers not including the filler materials is arranged between the first cover layer and one of the plurality of internal electrodes located closest to the first cover layer, and
wherein the second cover layer directly contacts another one of the plurality of internal electrodes located closest to the second cover layer.

2. The all solid battery as claimed in claim 1,
wherein, in the first cover layer and the second cover layer, the solid electrolyte forms a bone structure which is spatially continuously formed, and
wherein the filler materials are spatially dispersed in the solid electrolyte.

3. The all solid battery as claimed in claim 1, wherein the filler materials are alumina or silica.

4. The all solid battery as claimed in claim 1, wherein the solid electrolyte is a glass material which is an oxide-based solid electrolyte having a NASICON type crystal structure.

5. A circuit substrate comprising:
a substrate; and
the all solid battery of claim 1 mounted on the substrate,
wherein a first cover layer of the all solid battery faces the substrate.

6. A manufacturing method of an all solid battery comprising:
forming a multilayer structure by stacking a plurality of stack units, each having a structure in which an internal electrode pattern including an electrode active material powder is formed on a solid electrolyte green sheet including solid electrolyte powder;
stacking a cover sheet on an upper face and a lower face in a stacking direction of the multilayer structure, the cover sheet including a solid electrolyte and a filler material which is less likely causes necking than the solid electrolyte; and
firing the multilayer structure and the cover sheet,
wherein the solid electrolyte green sheet does not include the filler material.
